(19) United States
(12) Patent Application Publication
(10) Pub. No.: US 2005/0280354 A1
(43) Pub. Date: Dec. 22, 2005

(54) Light emitting diode

(76) Inventor: Shin-Lung Liu, Pingjhen City (TW)

Correspondence Address: TROXELL LAW OFFICE PLLC, SUITE 1404, 5205 LEESBURG PIKE, FALLS CHURCH, VA, 22041, US

(21) Appl. No.: 10/867,665

(22) Filed: Jun. 16, 2004

(51) Int. Cl. H01J 1/62

(52) U.S. Cl. 313/502

(57) ABSTRACT

A light emitting diode (LED) has the base of a chip buried in a fluorescent material comprised of fluorescent glue thus to be bonded to a support part; the space between the top layer and support as well as between the peripheral of the chip and a carrier being covered up with powder fluorescent material; the peripherals of the chip being covered up with the powder fluorescent material to balance the incorporation of the wavelength of the light emitted from the top and the peripheral of the chip, and that from fluorescent material to effectively avoid the development of diaphragm in strange color.

### BACKGROUND OF THE INVENTION

1. Field of the Invention

The present invention is related to an improved construction of a light emitting diode (LED), and more particularly to one that best fits for light emitting in white light.

2. Description of the Prior Art:

FIG. 1 of the accompanying drawings shows a schematic view of a structure of a light emitting diode of the prior art. Wherein, light emitted by a chip is incorporated with the wavelength of a fluorescent material to present effects of a specific light color. A bowl shape of carrier 20 is provided on a conduction end 10 of the LED to facilitate placement of a chip 30 and fluorescent material 40 into the carrier 20, and a gold plated wire 50 connects an electrode layer 31 and the conduction end 10 of the chip 30.

With the conduction end 10 is conducted, the light emitted through the fluorescent material 40 by the chip 30 is incorporated with the wavelength of the fluorescent material 40 to create a specific light color. For example, the white light LED of the prior art has the blue light emitted by the LED through a yellow fluorescent material; when the blue light wave is incorporated with the yellow light wave, they present the results of white light. However, in the structure of the LED of the prior art as illustrated in FIG. 1, the space over the top of the body of the chip 30 is not covered up with the fluorescent material, so that the light emitted straight upward is not subject to the wavelength incorporation with the fluorescent material as the light reflected from the peripheral of the chip 30 is. Therefore, the LED is vulnerable to create significant diaphragm in strange color.

In another prior art as illustrated in FIG. 2, the surface layer of the chip 30 is covered up with a layer of white insulation glue 61 in a certain thickness for the purpose to mitigate the presentation of the diaphragm in strange color through the transmission of the white insulation glue 61. However, the luminance of the LED is compromised as its light emitting is blocked by the presence of the white insulation glue 61.

Furthermore, another prior art yet as illustrated in FIG. 3 has poured into the space above the chip 30 a mixture comprised of the powder fluorescent material 40 and transparent glue 62, so that when the LED is in the baking process, the powder fluorescent material 40 is settled down on the top layer of the chip 30 and the base of the carrier 20 for correcting the significant diaphragm in strange color. However, the peripheral of the chip 30 remain unaffected by the fluorescent material 40, and the diaphragm in strange color still exists though not conspicuously.

### SUMMARY OF THE INVENTION

The primary purpose of the present invention is to provide an improved construction of a light emitting diode. Wherein, a chip is fixed at the carrier and the gold plated wire connects the electrode layer and the conduction end of the chip. Fluorescent material is provided to the surface layer and the base of the chip so that the peripheral of the chip is fully covered up by the fluorescent material. The fluorescent material provided to the base of the chip is of the type that allows the chip to be buried into the fluorescent glue and the fluorescent glue is used to bond the chip to the carrier while powder fluorescent material is used to cover up the surface layer of the chip by a small amount of transparent glue. Accordingly, once the LED is in the baking process, the powder fluorescent material consistently settles down on the top layer of the chip so to fill up the space between peripheral of the chip and the carrier, and further extends to connect the fluorescent material disposed at the base of the chip for balancing the incorporation of wavelength of the light emitted from the top layer and the peripheral of the chip and that from the fluorescent material to effectively avoid the presence of the diaphragm in strange color.

### BRIEF DESCRIPTION OF THE DRAWINGS

FIG. 1 is a schematic view showing a structure of a light emitting diode of the prior art.

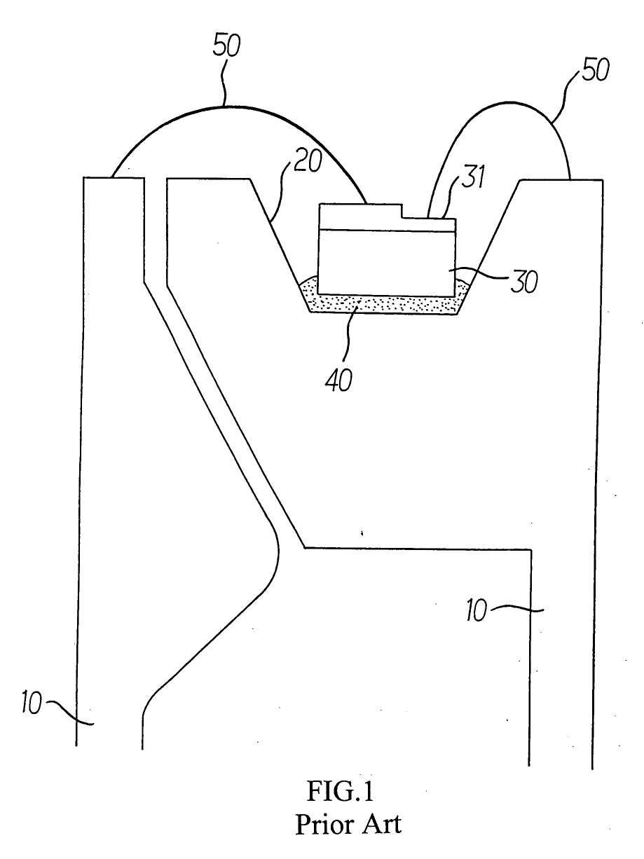

FIG. 2 is a schematic view showing a structure of a light emitting diode of another type of the prior art.

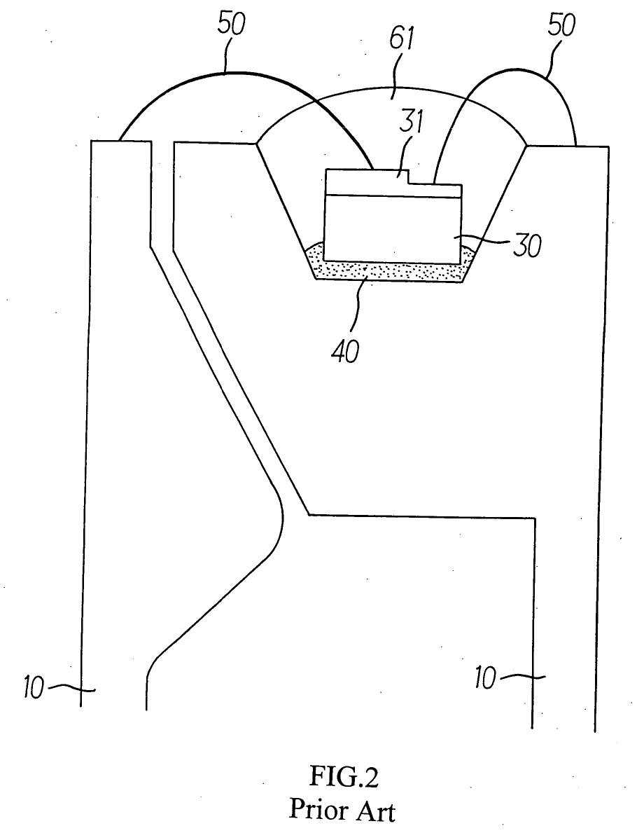

FIG. 3 is a schematic view showing a structure of a light emitting diode of another type yet of the prior art.

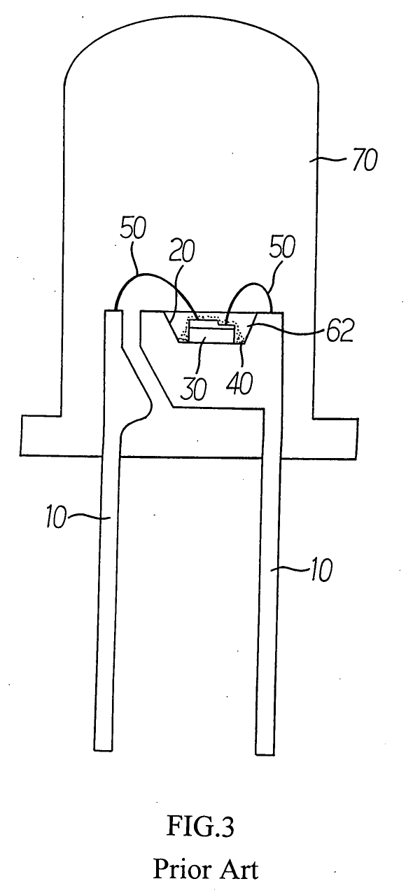

FIG. 4 is a schematic view showing a structure of a light emitting diode of a first preferred embodiment of the present invention.

FIG. 5 is a schematic view showing a structure of a light emitting diode of a second preferred embodiment of the present invention.

FIG. 6 is a schematic view showing a structure of a light emitting diode of a third preferred embodiment of the present invention.

### DETAILED DESCRIPTION OF THE PREFERRED EMBODIMENTS

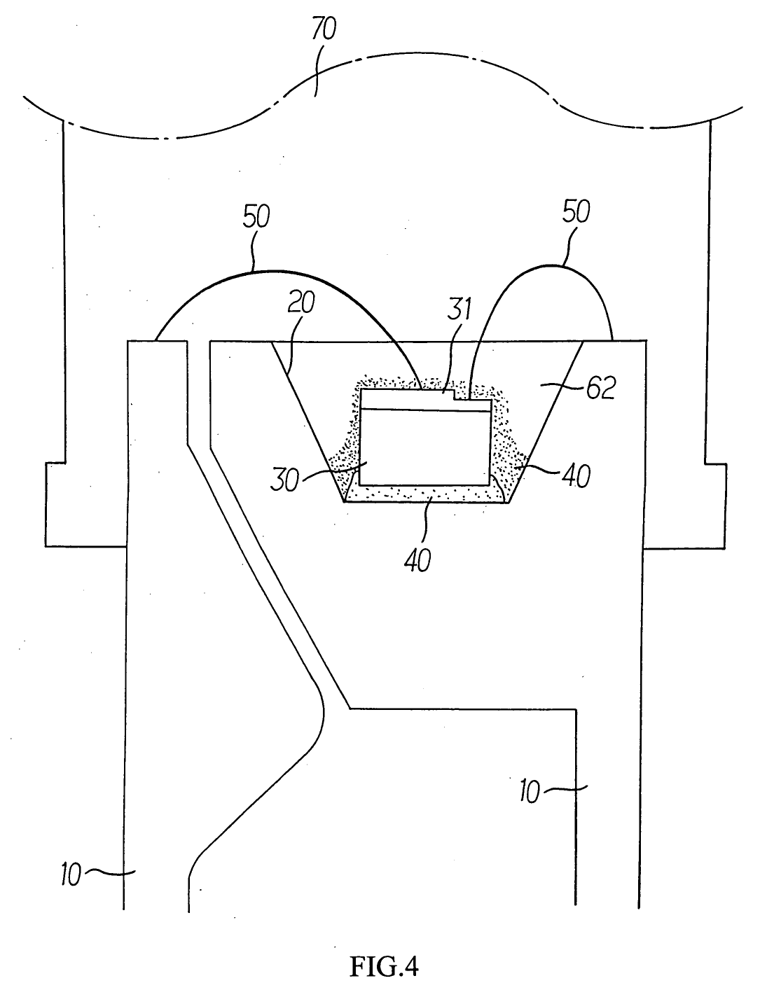

Referring to FIG. 4, an improved structure of a light emitting diode of the present invention is essentially comprised of multiple conduction ends 10 of various electrodes, and a carrier 20 provided in a transparent packaging material 70; a chip 30 and a fluorescence material 40 are placed in the carrier 20; a gold plated wire 50 connects an electrode layer of the chip 30 and the conduction end 10; and the fluorescent material 40 is also provided to the peripheral of the chip 30. Accordingly, when the conduction end 10 is conducted, the wavelength of the light emitted from the chip 30 through the fluorescent material 40 is incorporated with that of the fluorescent material to create a light in specific color.

The present invention takes its departure from the prior art in that the fluorescent material 40 provided at the base of the chip 30 is related to a type of fluorescent glue that permits the chip 30 to be embedded therein and thus to bond the chip 30 to the carrier 20. The fluorescent material 40 applied to the surface layer of the chip 30 relates to powder state. In the manufacturing process of the LED, the powder fluorescent material is mixed with a small amount of transparent glue so to facilitate pouring the fluorescent material into the space over the top of the chip 30. Once the LED is put in the baking process, the fluorescent material settles down and covers up the top layer of the chip, and fills up the space between the peripheral of the chip 30 and the carrier 20 while extending to connect the fluorescent material 40 applied at the base of the chip 30. After the powder fluorescent material 40 is finally settled down, the transparent glue 62 is stabilized and covers up the top layer of the entire chip 30 to protect the chip 30.

Accordingly, by balancing the incorporation of the wavelength of the light emitted from the top layer and the peripheral of the chip 30 and that from the fluorescent material 40, the development of diaphragm in strange color is avoided. In a first preferred embodiment of the present invention as illustrated in FIG. 4, the carrier 20 is related to a bowl shape structure provided on the conduction end 10, and the conduction end 10 extends out of a transparent packaging material 70 to serve as the pin for the LED to connect to a power source.

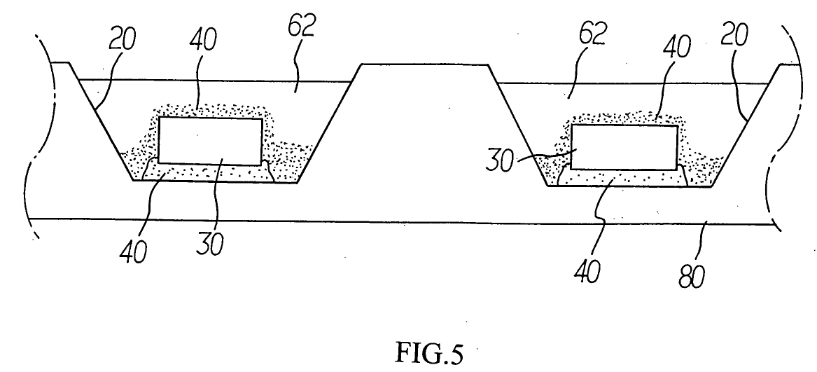

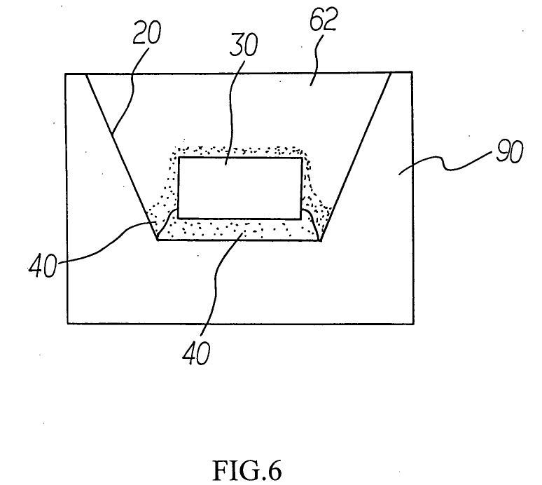

Alternatively as illustrated in FIGS. 5 and 6 for a second preferred embodiment of the present invention, the LED of the present invention is forthwith provided on a circuit board 80 or a plastic lead chip carrier (PLCC) 90. The carrier 20 is provided in a pit shape on the circuit board 80 or the PLCC 90. Each conduction end (not illustrated) is directly arranged on the circuit contact on the circuit board 80 or the PLCC 90.

The present invention provides an improved construction of a light emitting diode and this application for a utility patent is duly filed. However, it is to be noted that those preferred embodiments disclosed in the specification and the accompanying drawings are in no way limiting the present invention. Therefore, any construction, installation, or characteristics that is same or similar to that of the present invention should fall within the scope of the purposes and claims of the present invention.

1. An improved construction of a light emitting diode including a chip fixed to a carrier, a gold plated wire connecting an electrode layer and a conduction end of the chip, and fluorescent material being applied to the surface layer and the base of the chip, is characterized by that the fluorescent material applied to the base of the chip being related to a type of fluorescent glue; the chip being embedded in the fluorescent glue; the chip being bonded to the carrier by means of the fluorescent glue; the fluorescent material being of powder type to cover up the top layer of the chip and fill up the space between the carrier and the peripheral of the chip; the powder fluorescent material extending to connect the fluorescent material applied at the base of the chip; the peripheral of the chip being fully covered up by the fluorescent material; a protection transparent glue covering up the top layer of the entire chip; the wavelength of the light emitted form the top layer and the peripheral of the chip incorporated with that from the fluorescent material being balanced to avoid the development of a diaphragm in strange color.

2. An improved construction of a light emitting diode as claimed in claim 1, wherein, the carrier relates to a structure in a bowl shape.

3. An improved construction of a light emitting diode as claimed in claim 1, wherein, the carrier relates to a bowl structure provided on the conduction end.

4. An improved construction of a light emitting diode as claimed in claim 1, wherein, the carrier relates to a pit structure provided on a circuit board.

5. An improved construction of a light emitting diode as claimed in claim 1, wherein, the carrier relates to a pit structure provided on a injection molded plastic lead chip carrier.
